(19) United States
(12) Patent Application Publication
(10) Pub. No.: US 2026/0011061 A1
(43) Pub. Date: Jan. 8, 2026

(54) RESTYLING IMAGES USING A DIFFUSION MODEL WITH TEXT CONDITIONING AND A DEPTH MAP

(71) Applicant: Google LLC, Mountain View, CA (US)

(72) Inventors: Navin SARMA, Mountain View, CA (US); Selena SHANG, Mountain View, CA (US); Alex Rav ACHA, Mountain View, CA (US); Judy ZHU, Mountain View, CA (US); Clement NG, Mountain View, CA (US); Yael Pritch KNAAN, Mountain View, CA (US); Shlomo FRUCHTER, Mountain View, CA (US); Bryan FELDMAN, Mountain View, CA (US); Qinghao CHU, Mountain View, CA (US); Matan COHEN, Mountain View, CA (US)

(73) Assignee: Google LLC, Mountain View, CA (US)

(21) Appl. No.: 19/258,454

(22) Filed: Jul. 2, 2025

Related U.S. Application Data
(60) Provisional application No. 63/667,027, filed on Jul. 2, 2024.

(51) Int. Cl. G06T 11/60; G06T 7/11; G06V 20/64; G06V 40/10

(52) U.S. Cl. CPC G06T 11/60; G06T 7/11; G06V 40/10; G06T 2200/24; G06T 2207/20081; G06T 2207/20084; G06T 2207/20104; G06T 2207/30196; G06V 20/64

(57) ABSTRACT

A media application receives an initial image, user input that selects one or more objects in the initial image, and a textual request to generate an output image that modifies the one or more selected objects in the initial image. The media application generates a user-selected mask that includes object pixels corresponding to the one or more selected objects. A diffusion model receives the textual request to generate the output image, a depth map, and the user-selected mask, where the diffusion model is trained to generate output pixels that are not associated with a human subject. The diffusion model outputs the output image that satisfies the textual request.

### CROSS-REFERENCE TO RELATED APPLICATIONS

This application is a non-provisional application that claims priority under 35 U.S.C. § 119(e) to U.S. Provisional Patent Application No. 63/667,027, filed on Jul. 2, 2024 and entitled “Generating Images with Uncrop and Recomposition,” which is hereby incorporated by reference herein in its entirety.

### BACKGROUND

Generative artificial intelligence (AI) may be used to generate images from text prompts. Generative AI may also be used to create a modified version of a preexisting image based on a text prompt. The results generated by AI can be problematic in some contexts, especially when the images include people, because the more detailed aspects may be improperly represented. For example, generative AI is still imperfect when it comes to capturing the intricacies of features like fingers, eyes, and mouths in generated images. In addition, the generated images may lack a sense of realism.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method to generate an image based on a textual request includes receiving an initial image, user input that selects one or more objects in the initial image, and the textual request to generate an output image that modifies the one or more selected objects in the initial image. The method includes generating a user-selected mask that includes object pixels corresponding to the one or more selected objects. The method further includes providing, as input to a diffusion model, the textual request to generate the output image, a depth map, and the user-selected mask, wherein the diffusion model is trained to generate output pixels for the output image that are not associated with a human subject. The method further includes generating, with the diffusion model, the output image that satisfies the textual request.

In some embodiments, the depth map identifies depths of image pixels in the initial image and the output image preserves the depth map of the initial image. In some embodiments, depth is controlled with classifier-free guidance and a higher conditioning dropout value preserves a structure of the one or more selected objects in the initial image more than a lower conditioning dropout value. In some embodiments, the user input is provided from a user that performs one or more actions selected from a group of surrounding the one or more objects in the initial image, moving a finger over the one or more objects in the image, tapping on the one or more objects in the initial image, providing a textual identification of the one or more objects, and combinations thereof. In some embodiments, the methods further include performing object recognition to identify one or more humans in the initial image, where the input to the diffusion model further includes one or more preserving masks that identify human pixels corresponding to the one or more humans in the initial image, the one or more preserving masks being used by the diffusion model to prevent modification to human pixels. In some embodiments, the method further includes responsive to receiving the user input, performing object recognition to identify one or more types of the one or more selected objects and providing one or more suggestions for modifying the one or more selected objects based on the type of one or more objects. In some embodiments, the method further includes segmenting the one or more selected objects in the initial image and generating a segmentation mask that identifies the one or more selected objects, wherein the input to the diffusion model further includes the segmentation mask.

A method to train a diffusion model includes generating training data that includes initial images that have one or more selected objects and conditions, the conditions including, for each initial image, a textual request, a depth map, and a user-selected mask. The method further includes training the diffusion model to output images that satisfy the conditions and that do not include human pixels, wherein the training includes repeatedly generating the output images until a comparison of the output images to corresponding ground truth images satisfies a threshold loss value.

In some embodiments the method further includes segmenting the one or more selected objects in the initial image and generating a segmentation mask that identifies the one or more selected objects, wherein the conditions further include the segmentation mask. In some embodiments, the depth map includes depth values that identify a depth of image pixels in an initial image and training the diffusion model includes training the output images to preserve the depth maps associated with the initial images. In some embodiments the method further includes training the diffusion model based on varying amounts of the textual requests and the depth values by running a first version of the diffusion model with none of the textual requests and no depth values, running a second version of the diffusion model with the textual requests and no depth values, and running a third version of the diffusion model with the textual requests and the depth values. In some embodiments, the conditions further include classifier-free guidance and an amount of classifier-free guidance is based on a higher conditioning dropout value, the higher conditioning dropout value preserving a structure of the one or more selected objects in the initial image more than a lower conditioning dropout value. In some embodiments, the conditions further include preserving masks that identify human pixels corresponding to one or more human subjects in the initial images, the preserving masks being used by the diffusion model to prevent modification to human pixels during generation of the output images. In some embodiments, the training data further includes pairs of ground truth images and corresponding images with randomly masked portions of the ground truth images.

A non-transitory computer-readable medium includes instructions stored thereon that, when executed by one or more computers, cause the one or more computers to perform operations. The operations include receiving an initial image, user input that selects one or more objects in the initial image, and a textual request to generate an output image that modifies the one or more selected objects in the initial image; generating a user-selected mask that includes object pixels corresponding to the one or more selected objects; providing, as input to a diffusion model, the textual request to generate the output image, a depth map, and the user-selected mask, wherein the diffusion model is trained to generate output pixels for the output image that are not associated with a human subject; and generating, with the diffusion model, the output image that satisfies the textual request.

In some embodiments, the depth map identifies depths of image pixels in the initial image and the output image preserves the depth map of the initial image. In some embodiments, depth is controlled with classifier-free guidance and a higher conditioning dropout value preserves a structure of the one or more selected objects in the initial image more than a lower conditioning dropout value. In some embodiments, the user input is provided from a user that performs one or more actions selected from a group of surrounding the one or more objects in the initial image, moving a finger over the one or more objects in the image, tapping on the one or more objects in the initial image, providing a textual identification of the one or more objects, and combinations thereof. In some embodiments, the operations further include performing object recognition to identify one or more humans in the initial image, where the input to the diffusion model further includes one or more preserving masks that identify human pixels corresponding to the one or more humans in the initial image, the one or more preserving masks being used by the diffusion model to prevent modification to the human pixels. In some embodiments, the operations further include responsive to receiving the user input, performing object recognition to identify one or more types of the one or more selected objects and providing one or more suggestions for modifying the one or more selected objects based on the type of one or more objects. In some embodiments, the operations further include segmenting the one or more selected objects in the initial image and generating a segmentation mask, wherein the input to the diffusion model further includes the segmentation mask.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3A illustrates an example user interface that includes an initial image, according to some embodiments described herein.

FIG. 3B illustrates an example user interface that includes the initial image from FIG. 3A with user input and a textual request, according to some embodiments described herein.

FIG. 3C illustrates an example user interface that includes an output image that satisfies the textual request provided in FIG. 3B, according to some embodiments described herein.

FIG. 4 illustrates an example process of training a diffusion model to generate an output image from a textual request and an initial image, according to some embodiments described herein.

FIG. 5 illustrates an architecture of an example diffusion model, according to some embodiments described herein.

FIG. 6 is a flowchart of an example method to train a diffusion model to generate an output image based on a textual request, according to some embodiments described herein.

FIG. 7 is a flowchart of an example method to generate an output image from a textual request, according to some embodiments described herein.

### DETAILED DESCRIPTION

### Overview

Generative artificial intelligence (AI) models are employed to produce images based on textual prompts. A textual prompt is user-input text that represents an instruction/request in text form to an AI model for executing an action. In the present disclosure, the action is generation or modification of an image. However, existing generative AI technologies have various limitations, particularly when generating or modifying images that include human subjects. Current generative AI models frequently encounter difficulties in accurately representing intricate details of human features, such as fingers, eyes, and mouths, often resulting in inaccurate or unrealistic depictions in generated images. This issue becomes even more pronounced when a user attempts to modify specific aspects of an initial image that depicts human subjects, leading to undesirable alterations or artifacts in the human elements.

Prior solutions for image modification using generative AI lack mechanisms to consistently preserve the underlying structural characteristics of the image, such as depth information for existing objects within an image during a modification operation. This can lead to outputs that deviate significantly from the original image's spatial composition, undermining the desired outcome of a targeted modification.

Furthermore, current training methodologies for generative models do not sufficiently address the specific constraints required for controlled image modifications, particularly those involving human subjects.

The technology described herein addresses the issues above by training a diffusion model with initial images and conditions. The conditions, with reference to an initial image, include a textual request from a user to generate an output image that modifies one or more selected objects in the initial image, a depth map, and a user-selected mask where the user-selected mask includes objects pixels corresponding to the one or more selected objects. In some embodiments, the conditions may also include a segmentation mask that identifies the one or more selected objects. This may be used as a fallback to ensure that the one or more objects selected by the user are accurately identified. The diffusion model is also trained to generate output pixels that are not associated with a human subject. For example, the conditions may also include a preserving mask that identifies human pixels corresponding to one or more humans in the initial image.

The diffusion model described herein advantageously improves the quality of the output images that include human subjects by using a unique combination of conditions. For example, using a depth map preserves the depth from the initial image; combining the textual request with the user-selected mask ensures that the output image corresponds to user specifications of attributes for the output image as well as content of the output image; and the classifier-free guidance improves the overall output image quality. Training the diffusion model to generate output images that do not include human pixels improves the quality of the output images by reducing or eliminating hallucinations in the model output.

### Network Environment

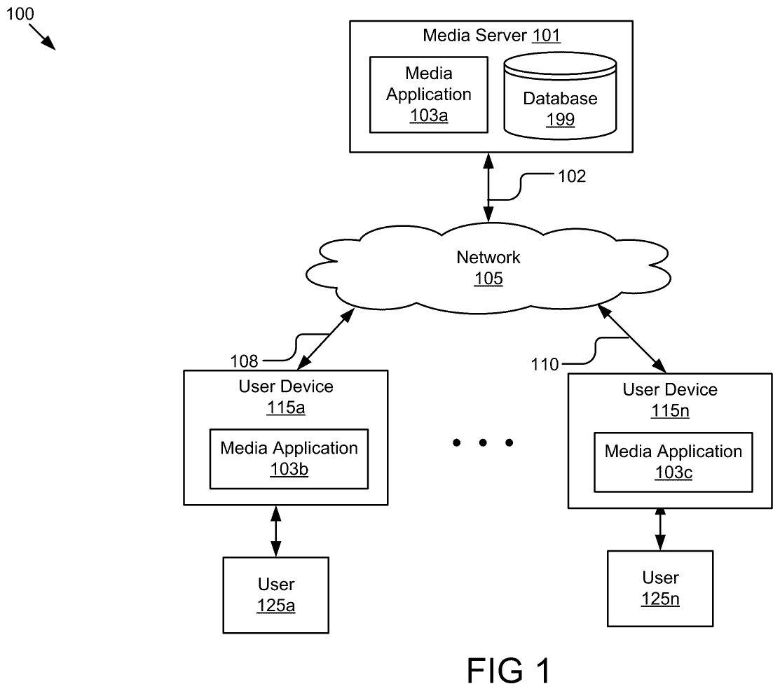

FIG. 1 illustrates a block diagram of an example network environment 100. In some embodiments, the environment 100 includes a media server 101, a user device 115a, and a user device 115n coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated implementation, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 or the user device 115. In some embodiments, the operations described herein are performed on the media server 101 or the user device 115. For example, a media application 103b on the user device 115a may receive an initial image captured by the user device 115a and generate an output image. In some embodiments, some operations may be performed on the media server 101 and some may be performed on the user device 115. For example, an initial image may be captured by the user device 115a and transmitted with user input and a textual request to the media application 103a on the media server 101, which generates an output image that is transmitted to the media application 103b on the user device 115a for display.

Performance of operations is in accordance with user settings. For example, the user 125a may specify settings that operations are to be performed on their respective device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine learning models (e.g., diffusion models or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

The media application 103 receives an initial image, user input that selects one or more objects in the initial image, and a textual request to generate an output image that modifies the one or more selected objects in the initial image. For example, a user may circle an object in the initial image and provide a textual request to change the object to a different object, add features to the object, etc. The media application 103 generates a user-selected mask that includes object pixels corresponding to the one or more selected objects.

The media application 103 includes a diffusion model that receives the textual request to generate the output image with modifications to the initial image, a depth map, and the user-selected mask. The diffusion model is trained to generate output pixels that are not associated with the human subject. The diffusion model may also receive a preserving mask that identifies human pixels corresponding to one or more humans in the input image. The diffusion model generates an output image that satisfies the textual request.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Computing Device

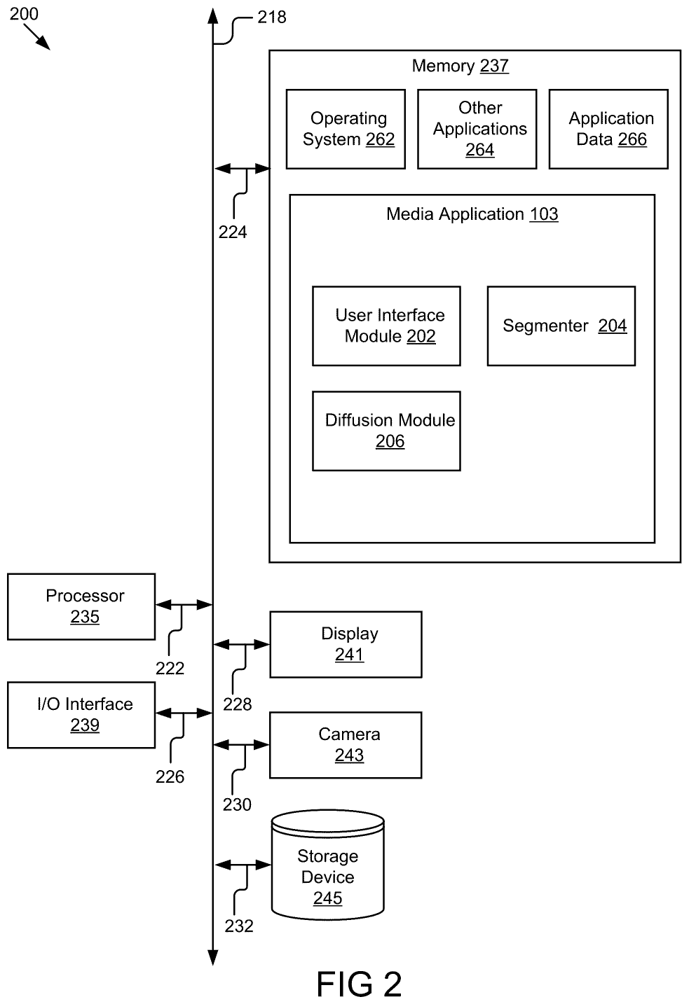

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

FIG. 2 illustrates an example media application 103, stored in memory 237, that includes a user interface module 202, a segmenter 204, and a diffusion module 206.

The user interface module 202 generates graphical data for displaying a user interface that includes images. The user interface module 202 receives initial images. The initial images may be received from the camera 243 of the computing device 200 or from the media server 101 via the I/O interface 239. The initial images may also be provided by a user, e.g., via an upload enabled by the user interface module 202.

Before the initial image is processed, the user interface provides a user with a request for user consent to modify the image. In some embodiments, such consent may be obtained once by the media application 103 for all future images. The user is provided with options to revoke such one-time consent and to require consent for each image. The user interface module 202 does not collect or make use of user information unless the user provides user consent.

The user may be provided with controls allowing the user to make an election as to both if and when systems, programs, or features described herein may enable collection of user information (e.g., information about a user's capture photographs or other images, social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city. ZIP code, or state level), so that a particular location of a user cannot be determined. Thus, the user may have control over what information is collected about the user, how that information is used, and what information is provided to the user.

The initial image includes one or more objects. In some embodiments, the initial image also includes one or more human subjects. The user interface module 202 receives user input that selects the one or more objects in the initial image. The user input may include surrounding the one or more objects in the initial image (e.g., by drawing a circle or other shape around an object), moving a finger over the one or more objects (e.g., a long press of one or more seconds, with a drag gesture over pixels of the image that depict the one or more objects), tapping on the one or more objects in the initial image one or more times (e.g., a double tap indicates a selection), providing a textual identification of the one or more images (e.g., “the tree on the right”), etc.

In some embodiments, the user interface may highlight the one or more selected objects in response to receiving the user input. In some embodiments, where a tap may be associated with multiple objects, a different number of taps may cause the user interface to highlight different objects. For example, where the initial image is a beach scene and a pail is in front of a sandcastle, tapping on the pail/sandcastle area a first time causes the pail to be highlighted first, tapping on the pail/sandcastle area a second time causes the sandcastle to be highlighted, and tapping on the pail/sandcastle area a third time causes both the pail and the sandcastle to be highlighted. In this manner, selection of individual objects that may be close to each other or may partially overlap in the initial image is enabled by mapping the tap count to individual objects or sets of two or more objects in the initial image.

The user interface module 202 generates a user-selected mask that includes object pixels corresponding to the one or more selected objects. In some embodiments, the user interface module 202 generates the user-selected mask by identifying all pixels that are associated with the user selection as belonging to the user-selected mask. In some embodiments, such as when the user input includes surrounding one or more objects in the initial image, the user interface module 202 generates the user-selected mask by performing object recognition to identify one or more objects that were surrounded by the user input and identifying pixels corresponding to the one or more identified objects as being part of the user-selected mask. The user interface module 202 provides the user-selected mask to the diffusion module 206.

In some embodiments, the user interface module 202 identifies objects (e.g., through performing object recognition) to identify the type of one or more objects in the initial image. The user interface module 202 may generate graphical data for updating the user interface to provide suggestions for modifying or replacing an object selected by a user. For example, if a user selects a mountain in an initial image, the user interface may include a suggestion to change the mountain to include snow, be greener, include animals on the mountain, etc. If the object is a human subject, the suggestions may include different types of outfits for the human subject. The suggestions may be based on objects that are commonly in proximity to the identified objects, based on objects that are most frequently requested as modifications based on the type of object, or a combination of both.

The user interface includes an option for providing a textual request associated with the one or more selected objects in the initial image. For example, the user interface may include a text field where the user directly inputs the textual request, an audio button for providing audio input that is converted to a textual request, etc. In some embodiments, the user interface may update with autocompleted suggestions while the user provides a textual request. For example, for an outdoor scene, where the text field includes “change to m” the user interface module 202 may add “mountains” as an autocomplete suggestion. In some embodiments, the textual request includes text associated with a suggestion displayed in the user interface and selected by the user.

In some embodiments, the user interface module 202 receives a textual request from a user to generate an output image and not user input that selects an object in an initial image. For example, the initial image may be paired with a textual request to change the sky in the initial image from midday to dawn.

In some embodiments, the user interface module 202 generates graphical data for displaying an output image. The user interface may also include options for editing the output image, sharing the output image, adding the output image to a photo album, etc.

### User Interfaces

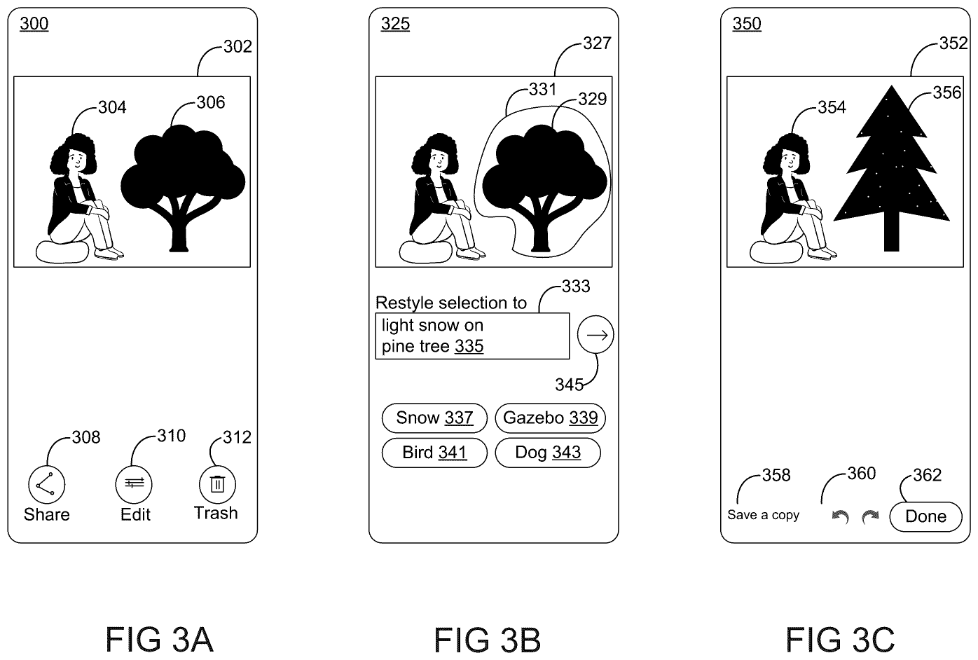

FIG. 3A illustrates an example user interface 300 that includes an initial image 302, according to some embodiments described herein. The initial image 302 includes a human subject 304 and a tree 306. The user interface 300 also includes a share button 308, an edit button 310, and a trash button 312. A user may select the edit button 310, which enables the user to select one or more objects in the user interface 300.

FIG. 3B illustrates an example user interface 325 that includes the initial image 327 (same as initial image 302 from FIG. 3A) with user input and a textual request 335, according to some embodiments described herein. In this example, the user provided input (e.g., touch input) to surround the tree 329 and the user interface module 202 updates the initial image 327 to highlight the tree with a line 331 to show that it was selected. The user interface 325 also includes a text field 333 where the user entered the following textual request 335: “light snow on pine tree.” In this example, the user input indicates that the tree 306 in the initial image (selected by the user) is to be replaced with a pine tree with light snow on it.

In some embodiments, the user interface module 202 provides suggestions for modifications to the initial image 327. For example, the suggestion may be based on a different season (e.g., change the weather conditions in the initial image from summer to winter), a different weather condition (e.g., add rain), and/or an effect (e.g., add shimmering). The user interface 325 also includes suggested modifications for the selected tree 329. In the example of FIG. 3B, the suggestions include snow 337, which could be added to the tree 329; a gazebo 339, which could replace the tree 329; a bird 341, which could be added to the tree; or a dog 343, which could replace the tree. In some embodiments, selecting one of the suggested modifications causes a corresponding textual request to be displayed in the text field 333 and the user may further modify it (not shown). For example, the user could select snow 337 and then modify the textual request 335 to be “light snow on pine tree” as shown in FIG. 3B Once the user is satisfied with the textual request 335, the user may select the arrow button 345 to request the output image to be generated.

FIG. 3C illustrates an example user interface 350 that includes an output image 352 that satisfies the textual request provided in FIG. 3B, according to some embodiments described herein. The output image 352 includes the human subject 354 (unmodified from the initial image 302) and a pine tree with light snow 356 (that replaces the tree 306 in the initial image 302). The user may save a copy 358, undo the changes 360, or select the done button 362. The human subject 354 in FIG. 3C is unmodified based on the segmenter 204 generating a preserving mask to prevent human pixels associated with the human subject 354 from being modified during the generation of the output image 352 by diffusion module 206 as is described in detail below.

In some embodiments, the segmenter 204 segments one or more objects selected by a user in an initial image. The segmenter 204 generates a segmentation mask that identifies object pixels associated with the one or more objects based on segmenting the one or more objects. In some embodiments, the segmentation mask is used in conjunction with the user-selected mask to identify the one or more selected objects for modification.

The segmenter 204 identifies whether a human subject is in the initial image. If the one or more objects selected by the user include a human subject, the segmenter 204 may segment a face of the human subject. The segmenter 204 may generate a preserving mask for a face that includes pixels that correspond to a location of the face in the initial image. The segmenter 204 segments the face of the subject in order to generate a preserving mask that is provided as input to the diffusion module 206 and the causes the diffusion module 206 to prevent modification to the face during generation of an output image. The preserving mask may correspond to the face to prevent modification to a subject's face while changing aspects of the subject's hair, clothing, etc.

The segmenter 204 may also segment more than the face, such as an entire body in cases where the entire body is prevented from being modified. The body segment includes pixels that correspond to a location of the body in the initial image. Body segmentation may be used to prevent modification to the entire body of the human subject while the rest of the image is modified, such as a change to a background of the initial image. In some embodiments, the preserving mask includes all aspects of the initial image except the part being modified. For example, the preserving mask may encompass the face, the hair, and a background while a subject's clothing is modified.

The segmenter 204 may segment the one or more objects in the initial image automatically or in response to user input. For example, where the user interface module 202 generates suggestions for objects in the initial image to modify, remove, and/or replace, the segmenter 204 segments the objects. In another example, the user interface receives user input identifying an object to be modified, removed, and/or replaced and the segmenter 204 segments the object in response to the object being selected. In some embodiments, the segmenter 204 generates a segmentation map that associates an identity with each pixel in the initial image as belonging to the face, the body, an object, etc. The segmentation map may be used to construct segmentation masks for different objects within the initial image.

The segmenter 204 may perform the segmentation by detecting objects in an initial image. The object may be a person, an animal, a car, a building, etc. A person may be a subject of the initial image or is not the subject of the initial image (e.g., a bystander captured in the initial image). A bystander may include people walking, running, riding a bicycle, standing behind the subject, or otherwise within the initial image. In different examples, a bystander may be in the foreground (e.g., a person crossing in front of the camera), at the same depth as the subject (e.g., a person standing to the side of the subject), or in the background. In some examples, there may be more than one bystander in the initial image. The bystander may be a human in an arbitrary pose, e.g., standing, sitting, crouching, lying down, jumping, etc. The bystander may face the camera, may be at an angle to the camera, or may face away from the camera.

The segmenter 204 may detect types of objects by performing object recognition, comparing the objects to object priors of people, vehicles, buildings, etc. to identify expected shapes of objects to determine whether pixels are associated with a selected object or a background. The segmenter 204 may generate a region of interest for the selected object, such as a bounding box with x, y coordinates and a scale.

The segmenter 204 generates a preserving mask that encompasses at least a face of the subject. The preserving mask for the face may comprise pixels corresponding to the pixels of the face segment in the initial image. In some embodiments, the preserving mask includes additional or different body parts of the human subject, such as an entire head, hands, a body of the subject, etc.

In some embodiments, the segmenter 204 generates a depth map for the initial image. A depth map is a representation of the distance or depth information for each pixel in the initial image. The depth map may be a two-dimensional array where each pixel contains a value that represents the distance from the camera (e.g., camera 243 if the computing device 200 captured the initial image) to a corresponding point in the scene. The depth map provides a continuous representation of the depth information of the scene captured in the initial image. The depth map may be generated using a depth sensor (if available in the initial image as metadata generated during image capture or by deriving depth from pixel values using depth-estimation techniques).

The segmenter 204 may generate the preserving mask based on generating superpixels for the image and matching superpixel centroids to depth map values to cluster detections based on depth. More specifically, depth values in a masked area may be used to determine a depth range and superpixels may be identified that fall within the depth range. Another technique for generating a preserving mask includes weighing depth values based on how close the depth values are to the preserving mask where weights are represented by a distance transform map.

In some embodiments, the segmenter 204 may specify a circuit configuration (e.g., for a programmable processor, for a field programmable gate array (FPGA), etc.) enabling processor 235 to implement a machine-learning model. In some embodiments, the segmenter 204 may include software instructions, hardware instructions, or a combination. In some embodiments, the segmenter 204 may offer an application programming interface (API) that can be used by the operating system 262 and/or other applications 264 to invoke the segmenter 204 e.g., to apply the machine-learning model to application data 266 to output the preserving mask.

The segmenter 204 uses training data to generate a trained machine-learning model. For example, training data may include pairs of initial images with one or more subjects and output images with one or more segmentation masks or preserving masks depending on whether the training is for generating segmentation masks or preserving masks.

Training data may be obtained from any source, e.g., a data repository specifically marked for training, data for which permission is provided for use as training data for machine learning, etc. In some embodiments, the training may occur on the media server 101 that provides the training data directly to the user device 115, the training occurs locally on the user device 115, or a combination of both.

In some embodiments, the segmenter 204 uses weights that are taken from another application and are unedited/transferred. For example, in these embodiments, the trained model may be generated, e.g., on a different device, and be provided as part of the segmenter 204. In various embodiments, the trained model may be provided as a data file that includes a model structure or form (e.g., that defines a number and type of neural network nodes, connectivity between nodes and organization of the nodes into a plurality of layers), and associated weights. The segmenter 204 may read the data file for the trained model and implement neural networks with node connectivity, layers, and weights based on the model structure or form specified in the trained model.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data. Such data can include, for example, one or more pixels per node, e.g., when the trained model is used for analysis, e.g., of an initial image. Subsequent intermediate layers may receive as input, output of nodes of a previous layer per the connectivity specified in the model form or structure. These layers may also be referred to as hidden layers. For example, a first layer may output a segmentation between a foreground and a background. A final layer (e.g., output layer) produces an output of the machine-learning model. For example, the output layer may receive the segmentation of the initial image into a foreground and a background and output whether a pixel is part of a preserving mask or not. In some embodiments, model form or structure also specifies a number and/or type of nodes in each layer.

In various embodiments, the trained model can include one or more models. One or more of the models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using training data, to produce a result.

Training may include applying supervised learning techniques. In supervised learning, the training data can include a plurality of inputs (e.g., images, segmentation maps, segmentation masks, preserving masks, etc.) and a corresponding ground truth output for each input (e.g., a ground truth segmentation mask that correctly identifies pixels corresponding to a selected object and/or a ground truth preserving mask that correctly identifies a portion of the subject, such as the subject's face, in each image). Based on a comparison of the output of the model with the ground truth output, values of the weights are automatically adjusted, e.g., in a manner that increases a probability that the model produces the ground truth output for the image.

In various embodiments, a trained model includes a set of weights, or embeddings, corresponding to the model structure. In some embodiments, the trained model may include a set of weights that are fixed, e.g., downloaded from a server that provides the weights. In various embodiments, a trained model includes a set of weights, or embeddings, corresponding to the model structure. In embodiments where data is omitted, the segmenter 204 may generate a trained model that is based on prior training, e.g., by a developer of the segmenter 204, by a third-party, etc. In some embodiments, the trained model may include a set of weights that are fixed, e.g., downloaded from a server that provides the weights.

In some embodiments, the trained machine-learning model receives an initial image with one or more selected objects. In some embodiments, the trained machine-learning model outputs one or more segmentation masks that identify object pixels associated with the one or more objects in the initial image. In some embodiments, if the one or more selected objects include a human subject, the trained machine-learning model generates one or more preserving masks that correspond to the one or more human subjects. For example, the one or more preserving masks may include image pixels that correspond to faces of the one or more subjects and exclude other pixels of the image.

The diffusion module 206 trains and implements a diffusion model to receive an initial image and a textual request to generate an output image; the segmentation mask as input and/or the preserving mask; and the depth map generated by the segmenter 204. In some embodiments, the initial image is described by Red Green Blue (RGB) color channels for each pixel with values in each color channel from 0 to 255.

The diffusion model generates an output image that satisfies the textual request and that does not include object pixels that are associated with a human subject. In some embodiments, the diffusion model receives an empty mask as input that identifies all the pixels in the initial image as being not associated with a human (regardless of whether the initial image includes a human). As a result of using the empty mask, the diffusion module 206 generates an output image that does not include human pixels.

In some embodiments where the initial image includes a human subject (either as a selected object or present in the image), the diffusion model also receives the preserving mask from the segmenter 204. The preserving mask is used to prevent modification by the diffusion model to the human subject during the generation of the output image.

In some embodiments, the diffusion module 206 trains a diffusion model with a two-step process to generate an output image. First, the diffusion model is trained to perform a forward diffusion process on an initial image where Gaussian noise with variance is added to obtain a noisy image. The Gaussian noise with variance is added to obtain progressively noisier images until the final noisy image is achieved. Second, the diffusion model is trained to perform a reverse diffusion process that uses a convolutional neural network (CNN) to transform the final noisy image into meaningful output (e.g., output image).

The diffusion module 206 trains the diffusion model to perform forward diffusion by using training data that includes initial images. The diffusion module 206 converts the initial images to tensors. A tensor is an array of bytes with any number of dimensions. The tensor may be described as having an arbitrary shape since the tensor may have any number of dimensions. The diffusion module 206 parses the bytes in the tensors to convert them into pixel data for the RGB color channels.

The diffusion module 206 may sample noise to match the shape (dimensions) of the initial images. The diffusion module 206 may sample random diffusion times and use these to generate the noise and signal rates according to a diffusion schedule. The diffusion module 206 applies weightings to the initial images to generate the noisy images. In some embodiments where the diffusion model is used to generate an output image from text, each forward diffusion step predicts the noise from a noisy image and text embedding generated from the text.

The diffusion module 206 calculates the loss (e.g., a mean absolute error) between the predicted noise and noise from a ground truth image and takes a gradient step against this loss function. After the gradient step, the neural network weights of the diffusion model (under training) are updated to a weighted average of the existing weights and the trained neural network weights.

The diffusion module 206 may train the diffusion model to perform reverse diffusion and denoise a noisy image so that it satisfies a textual request by instructing the neural network to predict the noise and then undo the noising operation using noise rates and signal rates. The diffusion model includes a CNN, which includes convolutional layers where the output of one layer serves as input to a subsequent layer. The convolutional layers include downsampling blocks, where the initial images are compressed spatially but expanded channel wise, and upsampling blocks where representations are expended spatially while the number of channels is reduced.

The diffusion module 206 provides a noise variance and the noisy image as described by tensors as input to a first convolutional layer in the CNN to increase the number of channels. The noise variance and the noisy image are concatenated across channels. In some embodiments, the diffusion module 206 includes skip connections between output from convolutional layers that perform downsampling and convolutional layers that perform upsampling for equivalent spatially shaped layers in the network. A final convolutional layer reduces the number of channels to the three RGB channels.

During training for the reverse diffusion process, the diffusion module 206 predicts noise in order to remove the noise from the noisy image to achieve the initial image. The diffusion module 206 performs the prediction over a number of steps and the number of steps may be different from the number of steps used during training for the forward diffusion process.

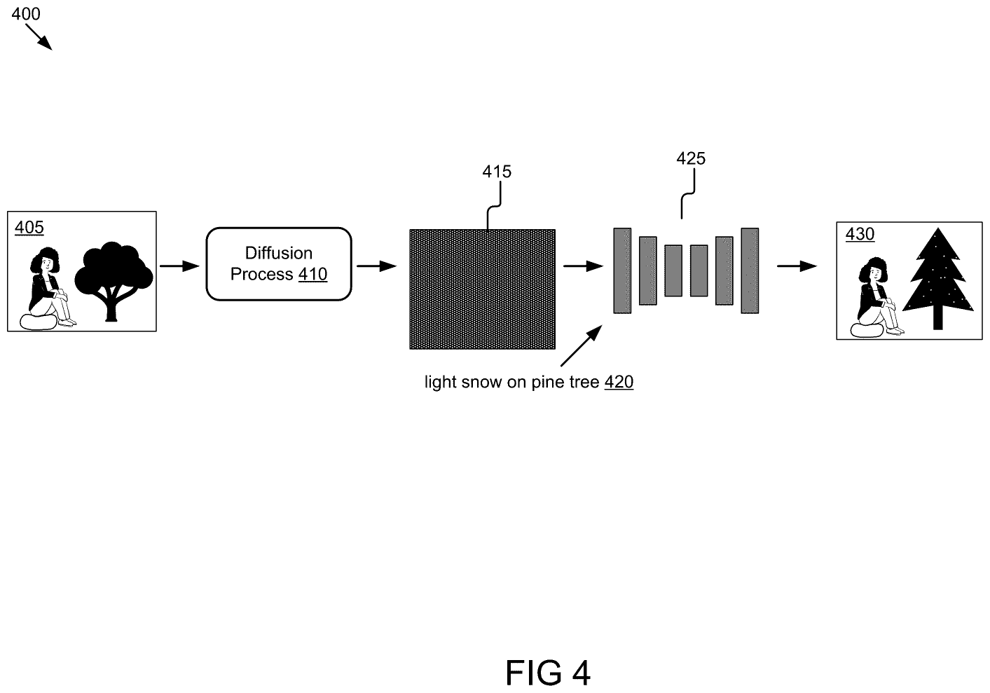

FIG. 4 illustrates an example process 400 of training a diffusion model to generate an output image 430 in response to a textual request 420 and an initial image 405, according to some embodiments described herein. The diffusion model includes a diffusion process 410 for performing forward diffusion and a CNN 425 for performing reverse diffusion.

An initial image 405 is provided as input to the diffusion process 410 that generates a corresponding noisy image 415. The initial image 405 is of a girl next to a tree. The noisy image 415 and the textual request 420 (“light snow on pine tree”) are provided as input to the CNN 425. In some embodiments, a user-selected mask is also received that identifies pixels associated with one or more selected objects in the initial image 405. The CNN 425 performs a reverse diffusion process to generate an output image 430 that satisfies the textual request.

The architecture of the diffusion model may include different components. When the diffusion model is used for generating an output image based on an initial image and a textual request, the diffusion model includes an image encoder, a text encoder, and a CNN. The diffusion model may start as a U-Net architecture, which is a specialized type of CNN, and may be modified to improve efficiency and promote output images that are photorealistic.

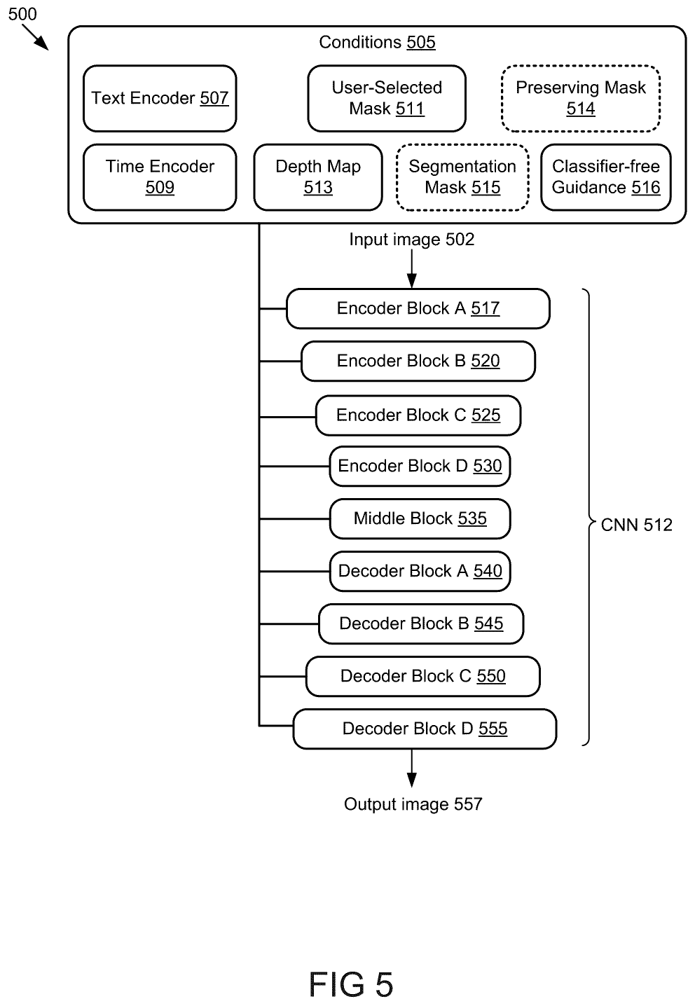

FIG. 5 illustrates an architecture of an example diffusion model 500, according to some embodiments described herein. The diffusion model 500 is trained using training data that includes initial images 502 and conditions 505. In some embodiments, the training data further includes ground truth output images, such as output images that satisfy textual requests. In some embodiments, training data further includes pairs of ground truth images and corresponding images with randomly masked portions of the ground truth images.

The conditions 505 include a text encoder 507, a time encoder 509, a user-selected mask 511, a depth map 513, an optional preserving mask 514, an optional segmentation mask 515, and classifier-free guidance 516. The text encoder 507 encodes a textual request (i.e., a textual condition) by converting the text to tokens for a vector that represents the textual request in vector space (embedding space). The time encoder 509 encodes diffusion timestamps using positional encoding.

The user-selected mask 511 identifies object pixels associated with one or more objects in the initial image. During inference (i.e., during generation of an output image), the user-selected mask 511 identifies the area to be modified in the output image. The user-selected mask 511 may identify object pixels that are associated with one or more selected objects.

The depth map 513 identifies a depth of one or more of the image pixels in the initial image. The depth map 513 is provided as input to the CNN 512 to preserve the relative depth of various objects in the initial image in the output image. For example, if a selected image includes a door with a handle, the depth map 513 is used to preserve the structure of the door and maintain the handle in the output image.

The preserving mask 514 identifies pixels that correspond to human subjects in the initial image and that are to be preserved during generation of the output image 557. For example, the preserving mask may include a human subject's hair if the user indicates that the hair to remain the same (or more generally, does not specify changes to the hair in conditions 505), the human subject's fingers, a subject's entire body where the subject is a pet to prevent the pet from being overly modified, etc. In some embodiments where the output image modifies the clothing of the human subject, the preserving mask excludes pixels of the clothing of the human subject and instead includes the remaining pixels associated with the human subject to prevent modification to the human subject by the diffusion model 500. In some embodiments, multiple different generative machine learning diffusion models may be trained and available for use in image generation, e.g., shape-preserving model, structure-preserving model, etc.

The segmentation mask 515 identifies the one or more selected objects. The segmentation mask 515 may be used to improve identification of the user-selected mask 511.

In some embodiments, instead of using a preserving mask 514, the conditions 505 may include an empty mask that identifies all pixels in the initial image 502 as not being associated with a human.

In some embodiments, the depth in the output image is controlled with classifier-free guidance 516. Classifier guidance controls the categories generated by a classification model. Classifier-free guidance 516 trains a diffusion model on conditions with conditioning dropout, which is when some percentage of the time, the conditions are removed. In some embodiments, removed conditions are replaced with a special input value that represents an absence of conditioning information. A higher conditioning dropout value preserves a structure of the one or more objects in the initial image more than a lower conditioning dropout value. One disadvantage of the higher conditioning dropout value is that the increased structure may come at a cost of decreased diversity of output images.

The initial image(s) 502 are provided as input to a first layer of a CNN 512 and the conditions 505 are provided as input to each block within the CNN 512. The CNN 512 includes encoder blocks 517, 520, 525, 530; a middle block 535; and skip-connected decoder blocks 540, 545, 550, 555. In some embodiments, the model is a diffusion model 500 and contains 25 blocks where 8 blocks are down-sampling or up-sampling convolutional layers. While FIG. 5 shows four encoder blocks and four decoder blocks, in various embodiments, fewer or greater numbers of encoder blocks and/or decoder blocks can be used (and the number of encoder blocks and the number of decoder blocks may be different).

The denoising process may occur in pixel space or in latent space of the diffusion model. In some embodiments, during training, the diffusion module 206 performs preprocessing on initial images 502 to convert the initial images 502 from pixel-space images to latent space (e.g., a vector representation of the image in high-dimensional vector space). The diffusion module 206 performs training by converting one or more of the conditions 505 from an input size to a feature space vector that matches the size of the CNN 512.

The diffusion module 206 trains the diffusion model to receive an initial image 502 and progressively add noise to the initial image 502 with each iteration of the diffusion model to produce a noisy image. Given a set of conditions 505 including time generated by the time encoder 509, textual requests encoded by the text encoder 507, and other task-specific conditions (e.g., the user-selected mask 511, the depth map 513, the preserving mask 514, the segmentation mask 515, and classifier-free guidance 516), image diffusion models are trained to predict the noise added to the noisy image. The diffusion module 206 trains the diffusion model to generate a plurality of output images (via a denoising process) that satisfy the textual requests and that do not include human pixels by progressively removing the noise. In some embodiments, the denoising during training includes about 10,000 optimization steps to minimize loss between generated output images and ground truth output images.

In some embodiments, the diffusion module 206 trains the diffusion model using three different versions of varying amounts of textual requests and depth values. For example, the diffusion module 206 may run a first version of the diffusion model with no textual requests and no depth values, run a second version of the diffusion model with the textual requests and no depth values, and run a third version of the diffusion model with the textual requests and the depth values. Training each version of the diffusion model may include multiple iterations.

Once a diffusion model is trained, the trained diffusion model receives the textual request to generate the output image, a corresponding depth map, and the user-selected mask, wherein the diffusion model is trained to generate output pixels that are not associated with the human subject. The diffusion model performs a diffusion process on the initial image to generate a noisy image based on the initial image. In some embodiments, the diffusion model performs an inverse diffusion process, such as a DDIM inversion, to generate an output image from the noisy image, where the output image is generated in accordance with conditions 505. The diffusion model performs reverse diffusion by predicting noise added to the noisy image and generating an output image that satisfies the textual request.

### Methods

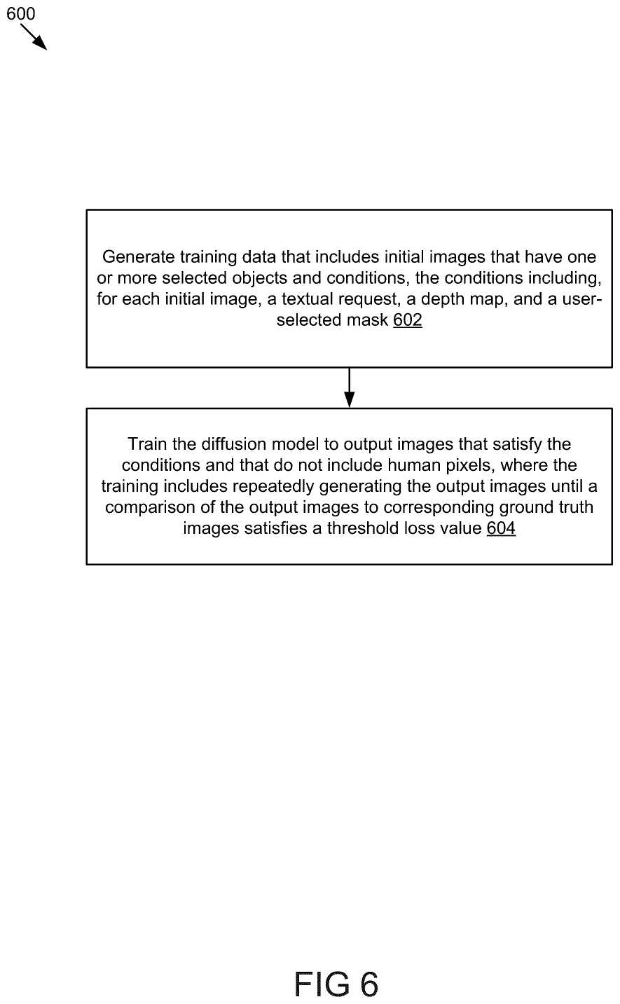

FIG. 6 illustrates an example method 600 to train a diffusion model to generate an output image based on a textual request. The method 600 may be performed by the computing device 200 in FIG. 2. In some embodiments, the method 600 is performed by the user device 115, the media server 101, or in part on the user device 115 and in part on the media server 101.

The method 600 of FIG. 6 may begin at block 602. At block 602, training data is generated that includes initial images that have one or more selected objects and conditions. The conditions include, for each image, a textual request, a depth map, and a user-selected mask. In some embodiments, the training data further includes pairs of ground truth images and corresponding images with masked portions of the ground truth images (e.g., randomly masked portions). The depth map may include depth values that identify a depth of image pixels in an initial image, where training the diffusion model includes training the output images to preserve the depth maps associated with the initial images.

The conditions may further include preserving masks that identify human pixels corresponding to one or more human subjects in the initial images, the preserving masks being used by the diffusion model to prevent modification to human pixels during generation of the output images. The method 600 may further include segmenting the one or more selected objects in the initial image and generating a segmentation mask, wherein the conditions further include the segmentation mask.

The conditions may further include classifier-free guidance of the depth maps such that a higher value preserves a structure of the one or more objects in the initial image more than a lower value. Block 602 may be followed by block 604.

At block 604, the diffusion model is trained to output images that satisfy the conditions and that do not include human pixels, where the training includes repeatedly generating the output images until a comparison of the output images to corresponding ground truth images satisfies a threshold loss value.

Training the diffusion model is based on varying amounts of textual requests and depth values. The training may include running the diffusion model a first time with none of the textual requests and no depth values, running the diffusion model a second time with the textual requests and no depth values, and running the diffusion model a third time with the textual requests and the depth values.

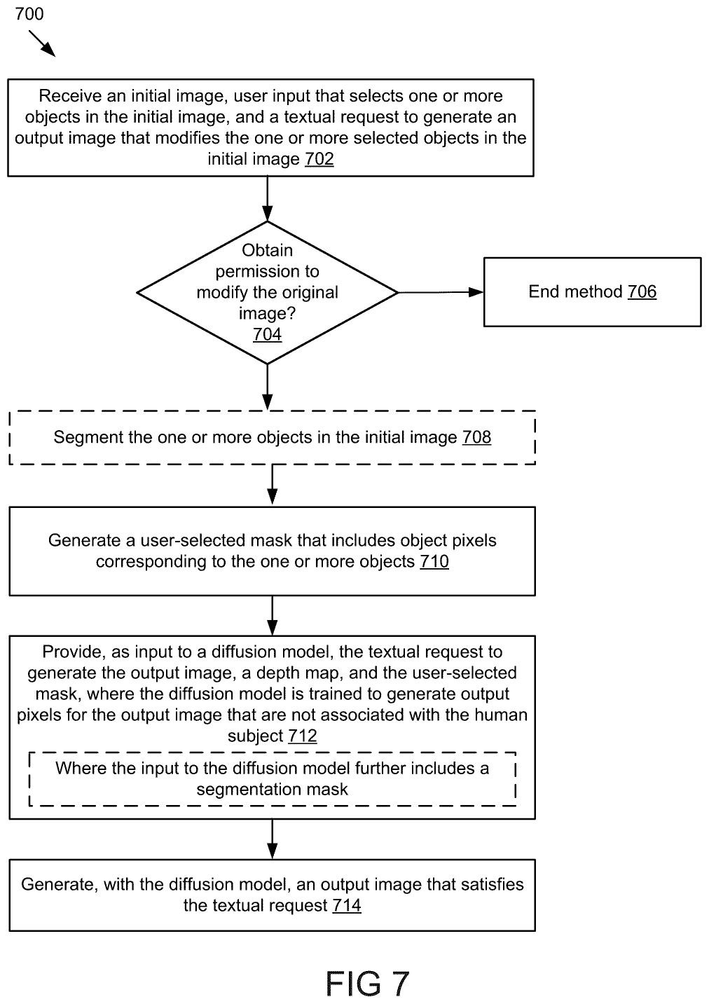

FIG. 7 illustrates an example method 700 to generate an output image from a textual request. The method 700 may be performed by the computing device 200 in FIG. 2. In some embodiments, the method 700 is performed by the user device 115, the media server 101, or in part on the user device 115 and in part on the media server 101.

The method 700 of FIG. 7 may begin at block 702. At block 702, an initial image, user input that selects one or more objects in the initial image, and a textual request to generate an output image that modifies the one or more selected objects in the initial image are received. The user input may be provided from a user that performs one or more actions selected from a group of surrounding the one or more objects in the initial image, moving a finger over the one or more objects in the image, tapping on the one or more objects in the initial image, providing a textual identification of the one or more objects, and combinations thereof.

In some embodiments, the method further includes responsive to receiving the user input, performing object recognition to identify one or more types of the one or more objects and providing one or more suggestions for modifying the one or more objects based on the type of one or more objects. Block 702 may be followed by block 704.

At block 704, it is determined whether permission is obtained to modify the original image. If permission is not obtained, block 704 may be followed by block 706. If permission is obtained, block 704 may be followed by block 708.

At block 708, the one or more objects in the initial image are optionally segmented. Segmentation masks (object masks) may be generated for the one or more objects in the initial image, where each mask identifies pixels of the initial image that belong to a respective object. Block 708 may be followed by block 710.

At block 710, a user-selected mask is generated that includes object pixels associated with the one or more objects. In some embodiments, the user-selected mask is generated based on user input (e.g., tapping, circling, or otherwise selecting an object) and based on the segmenting the one or more objects (e.g., matching the user input to a previously segmented object from block 708). Block 710 may be followed by block 712.

At block 712, a diffusion model receives the textual request to generate the output image, a depth map, and the user-selected mask as input. The diffusion model is pre-trained to generate output pixels that are not associated with the human subject and that are responsive to the textual request and the user-selected mask, and where the output image respects the depth map (e.g., generated objects added to the output image are at similar depth to the objects that they replace). The depth map identifies depths of image pixels in the initial image and the output image preserves the depth map of the initial image. The depth may be controlled with classifier-free guidance and a higher conditioning dropout value preserves a structure of the one or more objects in the initial image more than a lower conditioning dropout value. The input to the diffusion model may further include a segmentation mask.

In some embodiments, the method further includes performing object recognition to identify the one or more objects and one or more humans in the initial image, where the input to the diffusion model further includes one or more preserving masks that identify human pixels corresponding to the one or more humans (human faces and/or other parts of the body, such as limbs, hair, torso, etc.) in the initial image, the one or more preserving masks being used by the diffusion model to prevent modification to human pixels. Block 712 may be followed by block 714.

At block 714, the diffusion model outputs an output image that satisfies the textual request. The output image is provided to the user interface module 202 for display in a user interface. The user may use the output image as an input for further modifications, may save the output image, share the output image with others, etc. In various embodiments where the output image is shared with others, the output image may include metadata (or embedded pixel-level features) that enable identification of the output image as having been modified using generative AI.

In various embodiments, the textual request from the user may be subject to one or more filters to ensure that the generated output image is compliant with applicable rules and standards. For example, the filters may detect textual requests that prevent certain modifications to the image (e.g., addition of a prohibited category of object, changes to objects in the image that meet certain criteria, etc.). In response to such detection, the user is provided with guidance regarding the types of textual requests that are impermissible. Additionally, the user may be provided guidance regarding structuring the textual request to specify their requirement with respect to the output image.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method to generate an image based on a textual request, the method comprising:
receiving an initial image, user input that selects one or more objects in the initial image, and a textual request to generate an output image that modifies the one or more selected objects in the initial image;
generating a user-selected mask that includes object pixels corresponding to the one or more selected objects;
providing, as input to a diffusion model, the textual request to generate the output image, a depth map, and the user-selected mask, wherein the diffusion model is trained to generate output pixels for the output image that are not associated with a human subject; and
generating, with the diffusion model, the output image that satisfies the textual request.

2. The method of claim 1, wherein:
the depth map identifies depths of image pixels in the initial image; and
the output image preserves the depth map of the initial image.

3. The method of claim 2, wherein depth is controlled with classifier-free guidance and a higher conditioning dropout value preserves a structure of the one or more selected objects in the initial image more than a lower conditioning dropout value.

4. The method of claim 1, the user input is provided from a user that performs one or more actions selected from a group of surrounding the one or more objects in the initial image, moving a finger over the one or more objects in the image, tapping on the one or more objects in the initial image, providing a textual identification of the one or more objects, and combinations thereof.

5. The method of claim 1, further comprising:
performing object recognition to identify one or more humans in the initial image;
wherein the input to the diffusion model further includes one or more preserving masks that identify human pixels corresponding to the one or more humans in the initial image, the one or more preserving masks being used by the diffusion model to prevent modification to the human pixels.

6. The method of claim 1, further comprising:
responsive to receiving the user input, performing object recognition to identify one or more types of the one or more selected objects; and
providing one or more suggestions for modifying the one or more selected objects based on the type of one or more objects.

7. The method of claim 1, further comprising:
segmenting the one or more selected objects in the initial image; and
generating a segmentation mask, wherein the input to the diffusion model further includes the segmentation mask.

8. A computer-implemented method to train a diffusion model, the method comprising:
generating training data that includes initial images that have one or more selected objects and conditions, the conditions including, for each initial image, a textual request, a depth map, and a user-selected mask; and
training the diffusion model to output images that satisfy the conditions and that do not include human pixels, wherein the training includes repeatedly generating the output images until a comparison of the output images to corresponding ground truth images satisfies a threshold loss value.

9. The method of claim 8, further comprising:
segmenting the one or more selected objects in the initial image; and
generating a segmentation mask, wherein the conditions further include the segmentation mask.

10. The method of claim 8, wherein:
the depth map includes depth values that identify a depth of image pixels in an initial image; and
training the diffusion model includes training the output images to preserve the depth maps associated with the initial images.

11. The method of claim 10, further comprising:
training the diffusion model based on varying amounts of the textual requests and the depth values by running a first version of the diffusion model with none of the textual requests and no depth values, running a second version of the diffusion model with the textual requests and no depth values, and running a third version of the diffusion model with the textual requests and the depth values.

12. The method of claim 10, wherein:
the conditions further include classifier-free guidance; and
an amount of classifier-free guidance is based on a higher conditioning dropout value, the higher conditioning dropout value preserving a structure of the one or more selected objects in the initial image more than a lower conditioning dropout value.

13. The method of claim 8, wherein the conditions further include preserving masks that identify human pixels corresponding to one or more human subjects in the initial images, the preserving masks being used by the diffusion model to prevent modification to human pixels during generation of the output images.

14. The method of claim 8, wherein the training data further includes pairs of ground truth images and corresponding images with randomly masked portions of the ground truth images.

15. A non-transitory computer-readable medium with instructions stored thereon that, when executed by one or more computers, cause the one or more computers to perform operations, the operations comprising:
receiving an initial image, user input that selects one or more objects in the initial image, and a textual request to generate an output image that modifies the one or more selected objects in the initial image;
generating a user-selected mask that includes object pixels corresponding to the one or more selected objects;
providing, as input to a diffusion model, the textual request to generate the output image, a depth map, and the user-selected mask, wherein the diffusion model is trained to generate output pixels for the output image that are not associated with a human subject; and
generating, with the diffusion model, the output image that satisfies the textual request.

16. The non-transitory computer-readable medium of claim 15, wherein:
the depth map identifies depths of image pixels in the initial image; and
the output image preserves the depth map of the initial image.

17. The non-transitory computer-readable medium of claim 16, wherein the user input is provided from a user that performs one or more actions selected from a group of surrounding the one or more objects in the initial image, moving a finger over the one or more objects in the image, tapping on the one or more objects in the initial image, providing a textual identification of the one or more objects, and combinations thereof.

18. The non-transitory computer-readable medium of claim 15, wherein the operations further include:
performing object recognition to identify one or more humans in the initial image;
wherein the input to the diffusion model further includes one or more preserving masks that identify human pixels corresponding to the one or more humans in the initial image, the one or more preserving masks being used by the diffusion model to prevent modification to the human pixels.

19. The non-transitory computer-readable medium of claim 15, wherein the operations further include:
responsive to receiving the user input, performing object recognition to identify one or more types of the one or more selected objects; and
providing one or more suggestions for modifying the one or more selected objects based on the type of one or more objects.

20. The non-transitory computer-readable medium of claim 15, wherein the operations further include:
segmenting the one or more selected objects in the initial image; and
generating a segmentation mask, wherein the input to the diffusion model further includes the segmentation mask.
